(19) United States
(12) Patent Application Publication
(10) Pub. No.: US 2025/0377017 A1
(43) Pub. Date: Dec. 11, 2025

(54) POSITION SENSOR ROUTING SUPPORT, MAGNETIC BEARING MODULE AND PRODUCTION METHOD

(71) Applicant: SKF Magnetic Mechatronics, Saint-Marcel (FR)

(72) Inventors: Eduardo CARRASCO, Saint Etienne sous Bailleul (FR); Julien VAUBY, Rouen (FR); Nicolas POLO, Taverny (FR); Eddy HERISSE, les Andelys (FR)

(21) Appl. No.: 19/227,000

(22) Filed: Jun. 3, 2025

(30) Foreign Application Priority Data
Jun. 10, 2024 (FR) FR2406072

(51) Int. Cl. F16C 32/04; H02K 7/09; H02K 15/00

(52) U.S. Cl. CPC F16C 32/047; H02K 7/09; H02K 15/00

(57) ABSTRACT

A routing support (3) for a cable (14) for a position sensor for a magnetic bearing module (1). The position sensor for said magnetic bearing module (1) includes an arrangement of coils (11) wound on spools and an insulation displacement contact (12). The routing support (3) includes a track for routing said cable (14) and openings (4) allowing the insertion of said cable (14) in the insulation displacement contact (12) through some of the openings (4) when the routing support (3) is positioned facing said position sensor for said magnetic bearing module (1). A magnetic bearing module (1) includes such a routing support (3). A method of producing such a magnetic bearing module (1).

### CROSS-REFERENCE TO RELATED APPLICATION

This application claims priority to French Application No. 2406072, filed Jun. 10, 2024, the entirety of which is hereby incorporated by reference.

### FIELD

The present disclosure concerns a magnetic bearing module that includes a position sensor and a magnetic bearing and a production method for such a module.

The present disclosure aims to provide a magnetic bearing module that includes a position sensor routing support.

### BACKGROUND

A standard magnetic bearing module of a system such as an industrial machine includes a position sensor and one or more magnetic bearings.

Routing cables on a support plus crimping those cables by means of an insulation displacement contact enables simple and rapid creation of the circuit of a magnetic bearing position detector at the same time as guaranteeing electrical insulation.

To satisfy the aforementioned conditions, two standard wiring methods are used: connections made manually known as splices or using a printed circuit board (PCB).

The method of manually producing splice connections between the enamelled wires and the cables or between the enamelled wires themselves necessitates intermetallic soldering, an insulation step and a manual mechanical positioning step, followed by one or more steps of impregnation with a varnish for bonding and electrically insulating the assembly, followed by cleaning the mechanical interfaces before positioning the assembly in a magnetic bearing module.

This method cannot be automated and is therefore difficult to replicate, laborious and somewhat unreliable.

The method using a PCB in which the enamelled wires can be soldered directly to the printed circuit board or to a terminal passing through the board necessitates it being possible for the cables also to be soldered directly or via a connector with through-pins, the whole having to be retained using screwed or crimped attachments, and generally complementary overmoulding to provide mechanical protection and/or electrical insulation.

This method is particularly costly because it necessitates complex production tools and steps and rules out modular production using tools specific to one PCB design.

The present disclosure aims to propose a magnetic bearing module that can be assembled on an automatic line in a robot workstation, greatly reducing the time to produce the module at the same time as enabling dimensional adaptation of the production tools as a function of the required dimensions of the magnetic bearing modules.

The present disclosure also makes it possible to dispense with steps of overmoulding or impregnation for additional mechanical and/or electrical protection of the PCB to which the enamelled wire of the coil is directly soldered or connected, which steps entail long and difficult operations because they use chemical products and because of their curing and cleaning times.

### SUMMARY

The present disclosure has for object alleviating at least some of the aforementioned disadvantages and proposing a cable routing support for a position sensor module for a magnetic bearing module and the method of producing such a module capable of combining the advantages of speed, simplicity and reliability thereof over a wide range of magnetic bearing dimensions.

In view of the foregoing, the present disclosure has for object a cable routing support for a position sensor for a magnetic bearing module, said position sensor for a magnetic bearing module including an arrangement of coils wound around spools and an insulation displacement contact, said routing support including a track for routing said cable and openings configured to enable passage and insertion of said cable in the insulation displacement contact through some of the openings when the routing support is positioned facing said position sensor for the magnetic bearing module.

The routing track is formed on the routing support by at least one plurality of protuberances and/or serigraphs configured to delimit bearing surfaces of said cable for routing it along the routing support.

This routing track simplifies the process of producing magnetic position detectors using standard insulation displacement contacts, precise positioning of the coils accompanied by keying and a cable routing support that is light in weight and easy to use and eliminates the need for complex chemical processes, improving the thermal and chemical resistance of the cable and of the coils of the module, enabling modular production thereof with limited risk of error, more rapidly and more ecologically.

Above all, this method of prewiring the routing support plus the insulation displacement contact technology drastically reduces the duration of the very time consuming connecting steps, making this production method more reliable and automatable, but above all flexible to match demand since the production of this support with cable lengths and dimensions that can be modulated makes it possible to increase the number of references compatible with the same support for shorter or longer wiring runs installed in the same way on this support.

The routing support preferably includes at least one retaining slot configured to retain the cable by squeezing it for its insertion in the insulation displacement contact through the opening.

For example, the routing support includes two retaining slots placed on respective opposite sides of the opening.

The routing support advantageously includes passages for translation guide studs for the position sensor for the magnetic bearing module.

For example, the protuberances project on the same side of the routing plate to route the cable along the routing support from and to a connector of the routing support.

The support can include a plurality of routing tracks for a plurality of cables and, for reach routing track, the protuberances and/or serigraphs are arranged so as to retain laterally and intermittently on these two sides the cable disposed on this routing track.

In one embodiment there is produced on the one hand an assembly comprising a routing support and a cable disposed on the routing track and on the other hand a magnetic bearing module including a magnetic bearing coupled to a position sensor and an assembly comprising a routing support assembled onto said sensor and a cable disposed on the routing track, after which the cover is added to the routing support by passing said cover through the translation guide studs, after which said cover is retained by squeezing it against the routing support and squeezing said routing support against said position sensor by locking fixing means.

In one embodiment the position sensor includes translation guide studs having a circular shape with its axis parallel to an axis of revolution of said position sensor and passing through the passages.

The present disclosure also concerns a production method for such a magnetic bearing module during which the cable is inserted in the insulation displacement contact either by means of a pusher tool having a bearing head that is passed through the opening by pushing said cable or by means of a cover of the routing support that is passed through the opening by pushing said cable.

The production method preferably further provides for assembling the routing support onto the position sensor by guiding it in translation by means of the guide studs that are inserted in the passages.

### BRIEF DESCRIPTION OF THE DRAWINGS

The present disclosure will be better understood following detailed study of one embodiment depicted by way of non-limiting and illustrative example in the appended drawings, in which:

FIG. 1 represents a section of a position sensor of a magnetic bearing module without a cable routing support.

FIG. 2 represents the cable routing support for the position sensor as seen from the front.

FIG. 3 represents a perspective view of a part of the position sensor.

FIG. 4 represents a view in section in which a prior art cable retaining part is force fitted.

FIG. 5 represents a view in section of the use of a cable routing cover for inserting the cable in an insulation displacement contact of the magnetic bearing module.

FIG. 6 represents a perspective view of a tool for inserting a cable in an insulation displacement contact of the magnetic bearing module.

FIG. 7 represents another view in section of the use of a cable routing cover to retain the cable in an insulation displacement contact of the position sensor.

### DETAILED DESCRIPTION

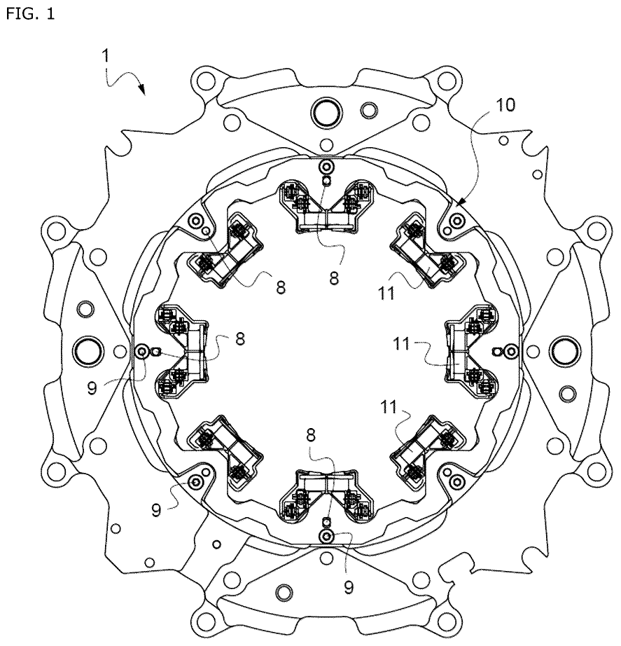

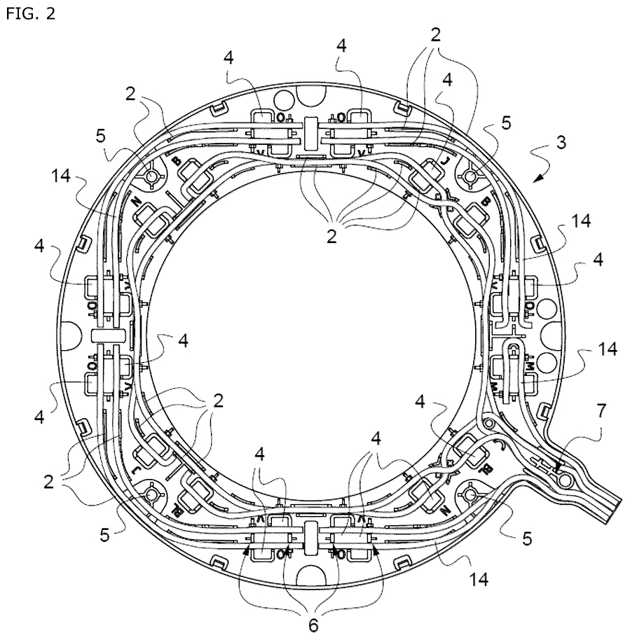

FIG. 1 depicts a magnetic bearing module 1 without its cable routing support 3 that is intended to receive such a cable routing support 3 such as the one depicted in FIG. 2.

The magnetic bearing module 1 includes a magnetic bearing, a position sensor 10 coupled to said magnetic bearing by connecting means such as screws 9 and a cable routing support 3 assembled onto said position sensor 10.

The position sensor 10 includes an arrangement of coils 11 and at least one insulation displacement contact 12.

FIG. 2 depicts said routing support 3 according to the present disclosure forming for example a plate or a shell for routing a cable 14.

The routing support 3 is configured to be assembled onto the position sensor 10 from FIG. 1 on which no cable routing support 14 has been mounted.

The expression “cable 14” designates interchangeably one or more flexible cables running in or intended to run in the routing track and including for example an enamelled wire and/or a multistrand cable.

The routing support 3 differs from prior art routing means employing manual assembly of the cables or a printed circuit for the electrical current in that it includes a track for routing said cable 14 and openings 4 configured to allow the insertion of said cable 14 in the insulation displacement contact 12 through some of the openings 4 when the routing support 3 is positioned facing said position sensor for a magnetic bearing module 1. Each opening 4 is formed by protuberances on the routing support 3 and is open on the side opposite said routing support. Each opening 14 is for example of rectangular shape so as to receive the cable of the insulating displacement contact 12.

The routing track is formed on the routing support 3 by at least one plurality of protuberances and/or serigraphs 2 configured to define bearing surfaces for said cable 14 for routing it along the routing support 3.

The protuberances and/or serigraphs 2 are adapted to form the routing track that extends over the entire circumference of the plate formed by the routing support 3.

The protuberances and/or serigraphs 2 for each routing track are for example spaced from one another in the circumferential direction, which makes it possible to limit the quantity of material used and to lighten the part.

The protuberances and/or serigraphs 2 for each track are arranged so as to retain the cable 14 laterally by two of its sides, which enables optimal retention despite the different successive orientations of the cable 14.

Each track can have a serpentine shape on the plate formed by the routing support 3, extending in a circular arc on the latter.

The routing track forms for example a loop that therefore enables routing of said cable 14 as far as a plurality of the coils 11 through the openings 4 to and from a single outlet 7 such as a connecting terminal or a connector configured to make the electrical connection between the magnetic bearing module 1 and an exterior system on which it is installed, such as an industrial machine.

All these connections enable creation of the radial and/or axial detection circuit or circuits that the position sensor 3 includes.

The protuberances 2 are for example complemented by serigraphs 2 projecting on the same side of the routing plate 3 to assist routing the cable 14 along the routing support 3 to or from the outlet 7 of the routing support 3.

There is thus formed an assembly comprising a routing support 3 and a cable 14 disposed on the routing track, the length of said cable 14 being adjustable at the moment of its installation on the routing support 3 without this changing the difficulty of this step of producing a magnetic bearing module 1.

Such a magnetic bearing module 1 with a routing track has the advantage of making it possible easily to reduce the number of variants of the design of the routing support, unlike modules including a printed circuit of fixed design, in which it is not possible for example to modify the electrical connection lengths to the exterior system at the level of the outlet 7.

The routing plate 3 therefore makes it possible to have a cable 14 or a bundle of cables 14 of the required length and already equipped with its connectors as a function of the required version and therefore to have varied length and connector references whereas the systems known from the prior art do not allow modular cable lengths.

This routing support 3 equipped with a cable track is modular since it can be mounted on any support having the same interfaces, namely the same distance between the axes of the pins and the same positions of the coils 11 and the insulation displacement contacts 12.

This routing support 3 can also be produced homothetically with different sizes to adapt to what is required with the ratio of the insulation displacement contacts 12 preserved and adapting the routing since the coils 11 are common to substantially all sizes.

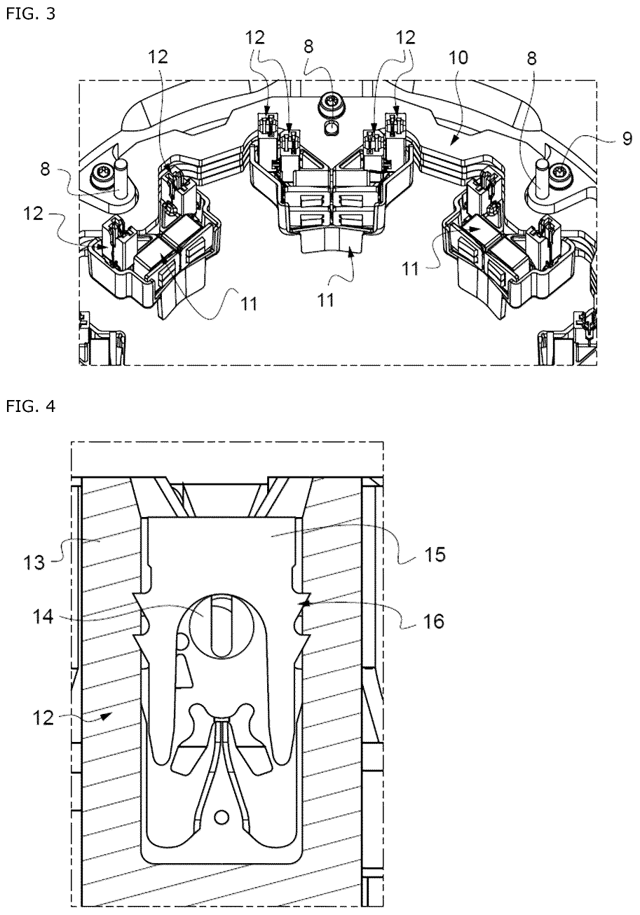

As depicted in FIGS. 1 and 3 the coils 11 can form pairs of wound assemblies positioned on the position sensor 10 at specific locations on the laminations constituting the discrete electromagnetic circuits of said position sensor 10.

These wound assemblies are positioned around a substantially concentric circular assembly in axial positions that can be different from one another but at precise radial distances relative to the centre of the circular assembly and also at precise angular positions, since these positions enable placing as far as the coils 11 of the insulation displacement contacts 12 at strategic locations for receiving the cable 14 to which the electric connection must be made.

The position sensor 10 can therefore include a plurality of insulation displacement contacts 12 and cables 14 connected to one or more routing tracks of said position sensor 10.

The cable 14 can also include at least in part the wire that is wound onto each spool to form the coils 11 and then routed to at least one opening 4 to make a connection to an insulation displacement contact 12 by inserting it therein and routed to the connector 7 intended to interface a system to which the magnetic bearing module 1 is connected.

The routing track therefore enables each cable 14 to be routed along the path provided for it thanks to the shapes on the routing support 3.

The routing support 3 is for example a plastic part including shapes and extrusions formed for example by screenprinting to obtain the routing track and facilitate its production.

Such a routing track enables good guidance of each cable 14 and reduces crossover errors.

The routing support 3 provides a support and mechanical protection for the circuit formed by the routing track for routing the cable 14 against possible environmental attack during the service life of the magnetic bearing module 1 or during its various production operations.

This routing support 3 also enables the cable 14 and the coils 11 to be held in their operational position throughout the service life of the module 3, guaranteeing that the electric insulation distances are maintained in accordance with predefined rules.

FIG. 3 represents a part of the magnetic bearing module 1 seen in a perspective view.

The spools for the coils 11 include a cavity to receive an insulation displacement contact 12 so that the magnetic bearing module 1 can include a plurality of insulation displacement contacts 12, for example from two to eight contacts in each quarter of the module 1.

For example, each coil 11 or pair of coils 11 includes two insulation displacement contacts 12, namely one at each end of the cable 14 that is to run in the routing track.

The position sensor 10 can include cables of different and mixed kinds, for example a cable 14 that includes on the one hand an enamelled wire on one side of an insulation displacement contact 12 and on the other hand a multistrand cable on the other side of the same insulation displacement contact 12.

This results in a position sensor of the magnetic bearing module 1 that involves no soldering and no impregnation for the cohesion of the coils 11 because immobilising the start and the end of the coil 11 prevents the latter from losing its coil tension and guarantees its integrity when handling and conveying it.

The routing support 3 for a cable 14 for a position sensor 3 preferably includes at least one retaining slot 6.

The retaining slot 6 is configured to clamp the cable 14 to retain it for its insertion in the insulation displacement contact 12 through the opening 4.

The slots 6 enable squeezing of the cable 14 to guarantee its retention during its insertion in the insulation displacement contact 12.

The routing support 3 includes for example two retaining slots 6 placed on respective opposite sides of the opening 4 on the protuberances defining said opening so as to retain said cable on either side of the insulation displacement contact 12 in a manner that is symmetrical and therefore stable, durable and reliable.

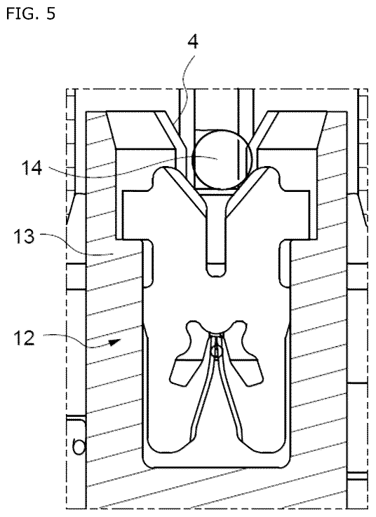

FIG. 4 represents a view in section of an insulation displacement contact 12 into which is force fitted a retaining part 15 that enables the cable 14 to be pressed into and retained in a base 13 of the insulation displacement contact 12.

This prior art retaining solution consists in forcing the usually metallic retaining part 15 of arcuate shape into the insulation displacement contact 12 and retaining it in position thanks to non-return barbs 16.

The present disclosure enables this type of retention to be replaced in the magnetic bearing module 1 of the present disclosure by direct use of the routing support 3 with its cover.

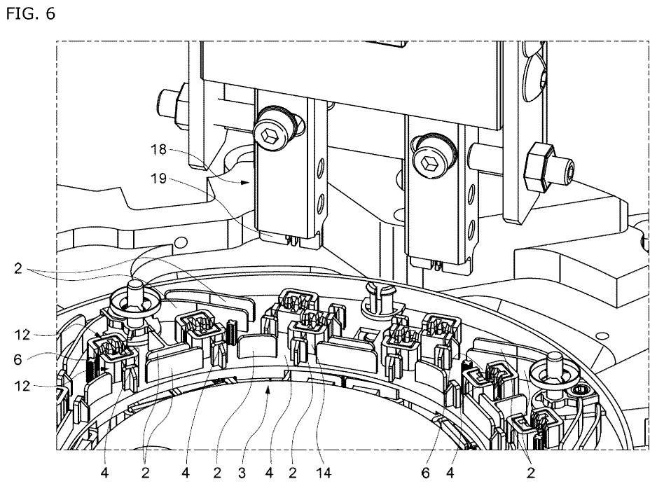

FIG. 6 represents a perspective view of a standard pusher tool 18 used for the insertion of the cable 14 in an insulation displacement contact 12.

The method of producing a magnetic bearing module 1 using such a tool includes a step in which the cable 14 is inserted in the insulation displacement contact 12 by means of the pusher tool 18, which has a bearing head 19 that is caused to pass through the opening 4 by pushing said cable 14.

When the bearing head 19 abuts mechanically on the routing support 3 insertion stops and the cable 14 is in position.

This method is effective and can be executed at high speed, but necessitates accurate and costly tooling with a plurality of bearing heads 19 or individual repetition of the insertion operation for each opening 4 through which the cable 14 passes as far as an insulation displacement contact 12.

FIG. 5 represents a view in section of the use of the cover of the routing support 3 to insert the cable 14 in an insulation displacement contact 12.

Thus the method of producing a magnetic bearing module 1 can, instead of using the pusher tool 18, insert the cable 14 in the insulation displacement contact 12 by means of the cover of the routing support 3, which is caused to pass through the opening 4 by pushing said cable 14.

This method makes it possible to dispense with the pusher tool 18 and also to connect the cable 14 directly since the cable 14 is positioned directly facing each opening 4 and each insulation displacement contact 12 to be connected and to push it through the respective opening 4 when said cable 14 is pushed by the routing support 3.

The assembly and connecting operations are reduced to simple mechanical insertions using the cover of the routing support 3 serving as a simple press instead of complex soldering necessitating skills and specific checking methods.

Positioning the insulation displacement contact 12 with the cables 14 in the routing support 3 makes it possible to absorb wider positioning tolerances than a rigid part including through-pins that have to be soldered or inserted by force.

Furthermore, assembly being flexible because of the plasticity of the routing support 3, vibrations during insertion of the routing support 3 do not impact the mechanical strength of the contacts or connections.

The routing support 3 does not need overmoulding with a resin to guarantee its mechanical integrity or insulation distances because the cables 14 themselves are already insulated, unlike the spots of solder and pressed contacts of the prior art.

The magnetic bearing module 1 can further include a position sensor 10 that includes translation guide studs 8.

The translation guide studs 8 each have a circular shape with its axis parallel to an axis of revolution of said position sensor 10.

The position of the coils 11 is therefore guaranteed by the distance between a bearing face of the position sensor 10 on the studs 8 which therefore serve also to seat the routing support 3.

The routing support 3 advantageously includes passages 5 for the translation guide studs 8 to pass through.

During the method of producing a position sensor of a magnetic bearing module 1 the routing support 3 can therefore be assembled onto the position sensor 10 by guiding it by means of the translation guide studs 8 as it slides in the passages 5.

There is obtained a good position of the routing support 3 during all the phases of the process of insertion of the routing guide 3 that is guided with the studs 8 serving for seating and fixing the routing support 3.

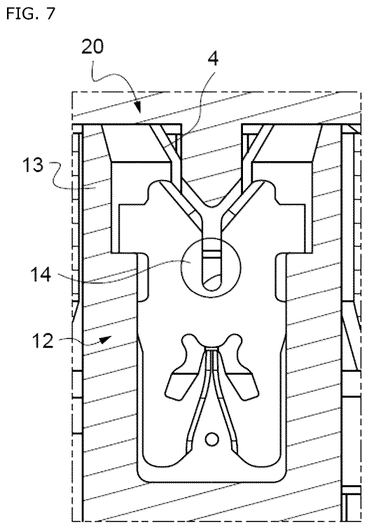

FIG. 7 represents another view in section of the use of the cover 20 of the routing support 3 to retain the cable 14 in an insulation displacement contact 12.

The cover 20 is added to the routing support 3 during the method of producing the position sensor of the magnetic bearing module 1.

Said cover 20 is then passed through the translation guide studs 8 after which said cover 20 is clamped to retain it against the routing support 3 and to clamp said routing support 3 against said position sensor 10 by locking fixing means.

The cover 20 is for example retained in position by means of nuts and bolts, rivets or, for a faster solution, external tooth washers.

The cover makes it possible to guarantee retention by squeezing the module in its entirety at the same time as forming a mechanical support for routing the cables 14.

Thanks to the routing support 3 for magnetic bearing modules there is therefore obtained a position sensor for which production method avoids long and complex steps are no longer necessary, enabling reduction of unit costs and favourable ecological impact and health impact through the reduction of harmful chemical agents that are difficult to recycle and the resistance to high temperatures and to chemical agents of which is greatly improved relative to existing solutions through the use of cables 14 and plastic parts that are not sensitive to the latter.

What is claimed is:

1. A routing support for a cable for a position sensor for a magnetic bearing module, said position sensor for the magnetic bearing module including an arrangement of coils wound around spools and an insulation displacement contact, the routing support comprising:
a track for routing said cable, the track including at least one plurality of protuberances and/or serigraphs configured to delimit bearing surfaces for said cable for routing the cable along the routing support; and
openings configured to enable insertion of said cable in the insulation displacement contact through some of the openings when the routing support is positioned facing said position sensor for the magnetic bearing module.

2. The routing support according to claim 1, further comprising at least one retaining slot configured to retain the cable by squeezing the cable for the insertion of the cable in the insulation displacement contact through the opening.

3. The routing support according to claim 2, wherein the at least one retaining slot includes two retaining slots placed on respective opposite sides of the opening.

4. The routing support according to claim 1, further comprising passages for translation guide studs for the position sensor for the magnetic bearing module.

5. The routing support according to claim 1, wherein the protuberances project on the same side of the routing plate to route the cable along the routing support to and from a connector of the routing support.

6. The routing support according to claim 1, wherein the protuberances and/or serigraphs are arranged so as to retain the cable disposed on the track laterally and intermittently on these two sides.

7. The routing support according to claim 3, further comprising passages for translation guide studs for the position sensor for the magnetic bearing module.

8. The routing support according to claim 7, wherein the protuberances project on the same side of the routing plate to route the cable along the routing support to and from a connector of the routing support.

9. The routing support according to claim 8, wherein the protuberances and/or serigraphs are arranged so as to retain the cable disposed on the track laterally and intermittently on these two sides.

10. An assembly comprising:
the routing support according to claim 9; and
the cable disposed on the routing track.

11. An assembly comprising:
the routing support according to claim 1; and
the cable disposed on the routing track.

12. A magnetic bearing module comprising:
a magnetic bearing;
a position sensor coupled to said magnetic bearing; and
the assembly according to claim 11 assembled onto said position sensor.

13. The magnetic bearing module according to claim 12, wherein the position sensor includes translation guide studs having a circular shape and the routing support includes passages for the translation guide studs, each translation guide stud having an axis parallel to an axis of revolution of said position sensor and passing through the passages.

14. A method for producing a magnetic bearing module according to claim 8, the method comprising:
inserting the cable in the insulation displacement contact either by means of a pusher tool having a bearing head that is passed through the opening by pushing said cable or by means of a cover of the routing support that is passed through the opening by pushing said cable;
adding, after said inserting, the cover to the routing support by passing said cover through the translation guide stud;
retaining, after said adding, the cover by squeezing the cover against the routing support and squeezing said routing support against said position sensor by locking fixing means.

15. The method according to claim 14, wherein the position sensor includes translation guide studs having a circular shape and the routing support includes passages for the translation guide studs, each translation guide stud having an axis parallel to an axis of revolution of said position sensor and passing through the passages, wherein the routing support is assembled onto the position sensor for the magnetic bearing module by guiding the routing support with the translation guide studs that are inserted in the passages and the cover is added to the routing support by passing said cover through the translation guide studs.
